(19) United States
(12) Patent Application Publication
(10) Pub. No.: US 2008/0092551 A1
(43) Pub. Date: Apr. 24, 2008

(54) Method and system integrating combustion turbine with a regenerative solar rankine power plant

(76) Inventor: Mark Joseph Skowronski, Irvine, CA (US)

Correspondence Address: Ronald Kincaid, 3052 Inverness Drive, Los Alamitos, CA, 90720, US

(21) Appl. No.: 11/974,849

(22) Filed: Oct. 16, 2007

Related U.S. Application Data
(60) Provisional application No. 60/852,301, filed on Oct. 18, 2006.

(51) Int. Cl. F02C 6/00; F03G 6/00

(52) U.S. Cl. 60/783; 60/641.8; 60/653

(57) ABSTRACT

A combustion turbine power generation system can be combined with a solar Rankine power generation system such that the integrated system has improved power generation efficiency over two stand-alone systems. This novelty has the solar heat input providing the heat of vaporization as well as a certain amount of superheat such that if the combustion turbine is not available, or is used in a different and more economical mode of operation, the solar Rankine cycle can be operated independently in a cost effective and efficient manner. In addition, to further improve the method of independent cycle operation, regenerative feedwater heating is proposed to be added to the solar Rankine cycle and to simplify the independent operation of the two cycles. The reheat cycle, as proposed by Cohen, is eliminated. Finally, the concept of variable pressure operation is proposed for this novelty to further ease the operation and improve the economics of independent cycle operations.

### CROSS-REFERENCE TO RELATED APPLICATIONS

This application claims the benefit of U.S. Provisional Patent Application No. 60/852,301, entitled “Integration of a combustion turbine into a solar Rankine cycle allowing independent operation of the combustion turbine (CT) and Rankine cycles,” filed on Oct. 18, 2006. This provisional application is incorporated by reference herein in its entirety.

### BACKGROUND OF THE INVENTION

1. Field of the Invention

The application relates generally to systems and methods for power generation and more specifically to systems and methods for integrating a fossil fueled combustion turbine power generation system with a solar Rankine power generation system with enhanced power generation efficiency.

2. Description of the Related Art

Studies and applications to date have centered on the incorporation of a solar Rankine cycle integrated into a conventional combined cycle. In the combined cycle application, the solar Rankine cycle supplies heat or steam to a combined cycle by adding heat to the Heat Recovery Steam Generator (HRSG) or by directly adding steam to the combined cycle's steam generator.

The combined cycle with solar applications vary in detail but have a significant disadvantage since the solar supplied heat is not a significant portion of the overall heat input resulting in a very low solar fraction relative to the overall combined cycle heat input. Consequently, the amount of solar energy relative to the combined cycle energy is small. Overall, on an annual basis, the amount of solar energy generated is approximate 6% to 8% of the overall combined cycle output (depending on the combined cycle's capacity factor). In addition, the combined cycle is essentially already optimized and the addition of solar heat can de-optimize the existing combined cycle resulting in penalties attributed to the solar addition. The direct use of a combustion turbine (CT) with a solar Rankine cycle will provide much greater efficiency, a higher solar fraction and more profitable economics than previous proposed cycles incorporating solar cycles into combined cycles.

### SUMMARY OF THE INVENTIONS

This invention incorporates a combustion turbine directly into the solar Rankine cycle and allows the solar fraction to be significantly higher when compared to incorporating solar heat into a combined cycle. In this novelty, the solar energy is used to supply both the heat of vaporization and partial superheat (limited only by the operating temperature of the heat collection fluid which is typically high temperature oil); additional superheat is then supplied with the enthalpy of the CT exhaust heat and then the remaining CT exhaust heat is used to supply the feedwater heating.

In a Rankine cycle, the bulk of the heat required is the latent heat of vaporization. The solar heat is ideal to provide this heat and, if independent cycle operation is desired, i.e. the ability to efficiently run the solar Rankine cycle separately from the CT, solar heat can also be used to supply superheat. Typically, this is limited to approximately 700 F. Additional superheat may then be supplied by the CT exhaust heat. This heat addition is typically that amount of heat supplied to the steam above 700 F. In current solar Rankine cycle designs, the 700 F superheat (approximate) is due to oil limitation; steam typically cannot be heated higher than ˜700 F due to the temperature limitation of the oil, which is used to collect the solar heat (other heating fluids can be used). The oil is used to heat the steam and hence the oil temperature limitation of ˜730 precludes higher steam (working fluid) operating temperatures.

After using the exhaust gas of the combustion turbine to further heat the steam past 700 F, there is sufficient heat remaining in the combustion turbine exhaust that also allows pre-heating of the feedwater. The pre-heating of the feedwater improves the cycle efficiency by reducing the amount of overall heat required for the Rankine cycle. This cascade of heating by the combustion turbine, first to the main steam and then to the feedwater allows a balanced and total use of the exhaust heat of the combustion turbine.

The overall process of this novelty allows for a greater proportion of solar heat by providing the latent heat of vaporization and partial superheat and then allows the combustion turbine to provide heat to further superheat the working fluid and then using the excess amount of heat left in the exhaust to heat the feedwater. The feedwater, as proposed in this novelty, may also be heated by separate regenerative heaters when the CT is not available.

Higher Rankine cycle efficiency results since there is additional heat added to the Rankine cycle by using the waste heat of the combustion turbine either by increasing the working fluid superheat or by increasing feedwater temperature or by both increasing the superheat and pre-heating the feedwater. This method of incorporating a combustion turbine into the Rankine cycle provides significant cost reductions and efficiency increases when compared to the conventional method of generating solar generated electricity such as the existing Solar Electric Generation Stations (SEGS) located in the high desert of southern California. The SEGS method uses a Rankine cycle that is “boosted” with a natural gas fired boiler. When compared to the SEGS method, this novelty, proposed herein, of using a combustion turbine(s) in conjunction with a solar Rankine cycle generation uses the CT fuel in a much more efficient manner by generating electricity first with a combustion turbine prior to using the combustion turbine's waste heat and using the solar heat to primarily provide the latent heat of vaporization into the solar Rankine cycle. This novelty incorporates a superheater in the solar boiler and adds a regenerative heater(s) to allow a de-coupling of the two cycles, i.e. the CT cycle and the solar Rankine cycle permitting independent operation of each cycle.

Due to the many combustion turbines that are on the market, considerable variation in the proposed solar/CT cycle can be realized. The heat rate of the combustion turbine, the amount of exhaust flow and temperature, the operating temperature, pressure and steam flow of the Rankine cycle must all be optimized and balanced. This novelty allows for a large variation of CT's that can be utilized in the cycle due to the flexibility provided by the independent operation of the two cycles proposed in this novelty.

### BRIEF DESCRIPTION OF THE DRAWINGS

The above-mentioned and the other features of the inventions disclosed herein are described below with reference to the drawings of the preferred embodiments. The illustrated embodiments are intended to illustrate, but not to limit the inventions. The drawings contain the following figures:

FIG. 1 is a schematic diagram of an embodiment of an integrated power generation system;

FIG. 2 is a schematic diagram of another embodiment of an integrated power generation system.

### DETAILED DESCRIPTION OF THE PREFERRED EMBODIMENTS

The following discussion describes in detail several embodiments of power generation systems and various aspects of these embodiments. This discussion should not be construed, however, as limiting the present inventions to those particular embodiments. Practitioners skilled in the art will recognize numerous other embodiments including those that can be made through various combinations of the aspects of the illustrated embodiments.

It is noted that Cohen (U.S. Pat. Nos. 5,727,379 and 5,857,322) teaches that the solar heat must be used for the heat of vaporization only. Cohen also teaches that the exhaust gas of a CT should be split for the purposes of providing superheat to the saturated steam leaving the solar boiler and that a reheat cycle must be used to fully exploit the cycle. Cohen teaches that after superheat is provided to the high pressure saturated steam generated in the solar boiler and partially expanded in the turbine, the additional heat in the CT exhaust is also used to add superheat to the cold reheat steam (through the use of a reheater). The remaining enthalpy of the CT exhaust gas (after providing superheat to both the high pressure and low pressure (reheat) steam) is then used to preheat the feedwater entering the solar boiler. However, a severe limitation exists in the Cohen concept in that the CT must be operating simultaneously with the solar system for the solar system to operate efficiently. This novelty herein, while acknowledging the contributions of Cohen, yields an economically and more commercially attractive concept by de-coupling the CT and solar Rankine cycle. For real world deployment, the certain modifications proposed in this novelty, as described herein, make the Cohen invention simpler, and more practical, versatile and profitable.

This novelty has the solar heat input providing the heat of vaporization as well as a certain amount of superheat such that if the CT is not available, or is used in a different and more economical mode of operation, the solar Rankine cycle can be operated independently in a cost effective and efficient manner. In addition, to further improve the method of independent cycle operation, regenerative feedwater heating is proposed, as well as separate solar feedwater, and to simplify the independent operation of the two cycles, the reheat cycle, as proposed by Cohen, is eliminated. Finally, the concept of variable pressure operation is proposed for this novelty to further ease the operation and improve the economics of independent cycle operations.

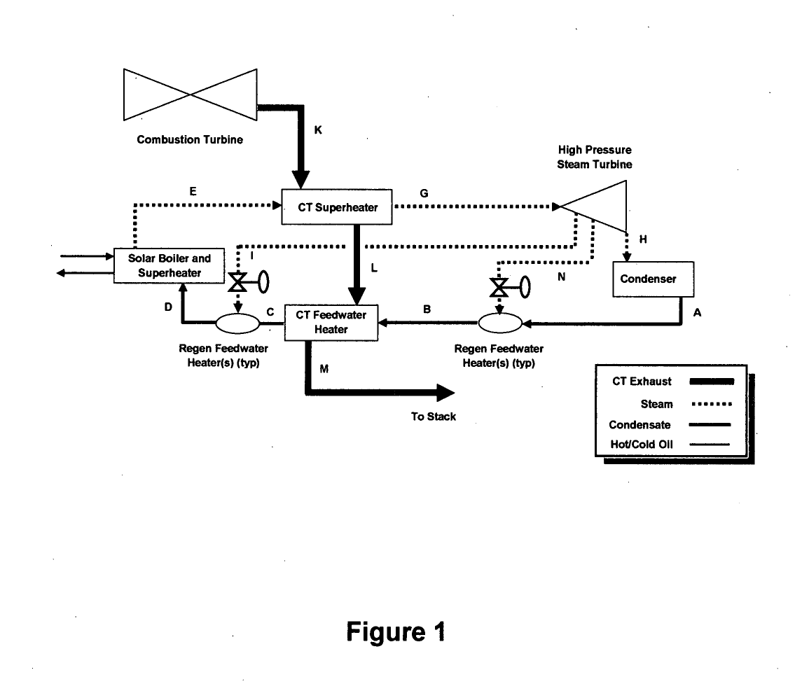

The novelty improves the commercial operation of the Cohen concept through the advancement of five changes (refer to FIG. 1):
1) Capability to run the solar Rankine cycle independently from the CT;
2) Adding a regenerative heater(s), and solar feedwater heater(s) as necessary, to allow for greater operational flexibility, improve efficiency and provide better economics;
3) Eliminating the reheat cycle proposed by Cohen to create simplicity and operational flexibility;
4) Ability to change steam parameters (pressure and temperature) from the solar boiler to optimize system; and,
5) Incorporating variable pressure operation in the solar Rankine cycle to allow for greater efficiency when the CT is not available to provide exhaust heat into the solar Rankine cycle.

### 1) Independent Operation of the Solar Rankine Cycle and the CT Cycle.

Cohen teaches that the CT must always be operated and used in conjunction with the solar Rankine cycle since without the CT exhaust heat there is no superheating and there is no feedwater heating; consequently the CT and solar Rankine cycles cannot be decoupled for efficient solar operations. The lack of independent solar operation results in a significant economic penalty since by de-coupling the two cycles, i.e. providing the means to run independently in an efficient fashion, yields greater operational flexibility and better economics ensue. This novelty incorporates a superheater in the solar Rankine boiler such that steam up to a typical temperature limit of ˜700 F can be reached. Typically, a high temperature oil such as Therminol, is used and, consequently, a solar boiler is limited to produce ˜700 F steam since the high temperature oil is limited to ˜730 F and a certain temperature difference is required for heat exchange. In this new novelty, the superheated steam at ˜700 F that is produced in the solar boiler is then directed to the CT superheater that is heated from the CT exhaust which adds additional superheat, typically to 1000 F to 1050 F. Accordingly, when the CT is not in operation and not providing exhaust heat, the solar Rankine cycle can still operate with superheated steam instead of just saturated steam. Without the additional superheater in the solar boiler, the efficiency of the solar Rankine cycle is severely limited since it then would revert back to a saturated steam cycle if the CT exhaust heat is unavailable. In addition, the lack of feedwater heating, when the CT is not operational, would yield a severe operating penalty.

It is recognized that with the CT in operation, greater superheat temperatures are realized; however, this novelty allows de-coupling of the CT from the solar Rankine cycle and still manages to provide superheat steam to the steam turbine albeit at a lower temperature. Economically, this novelty provides significant economic benefit. The de-coupled CT is now free to provide dispatchable power and standby capacity as needed while the solar Rankine cycle can continue to provide as-available energy during all periods of solar insolation availability.

In addition, since Cohen teaches that the remaining enthalpy in the CT exhaust after superheating and reheating is used for feedwater heating, a regenerative feedwater heater(s) is also proposed to provide feedwater heating when the CT is not operating. (See next change.)

### 2) Addition of Regenerative Feedwater Heater(s) Before and After the CT Feedwater Heater

In order to provide feedwater heating that supplements the CT exhaust feedwater heating and to provide a measure of feedwater heating when the CT exhaust heat is not available, a conventional regenerative feedwater heater is proposed. The addition of a steam extraction feedwater heater prior to the CT Feedwater Heater, can then be used to further boost the feedwater temperature to the solar boiler when the CT exhaust heat is not available for feedwater heating. Typically the first low pressure heater can provide approximately 50 F temperature rise in the feedwater temperature, as measured from the condenser well. Accordingly, when the CT is operating, the feedwater temperature to the CT Feedwater Heater would be approximately 150 F; this allows sufficient temperature differential for the waste heat of the CT to heat the feedwater and still approach the dew point of the exhaust gas that is typically in the 180 F to 200 F temperature range.

Additional regenerative feedwater heaters, using extraction steam, can then be serially placed subsequent to the CT Feedwater Heater. In this manner, when the CT Feedwater Heater is not operational due to the non-operation of the CT, then the extraction steam to the regenerative heaters downstream of the CT Feedwater Heater will automatically adjust to provide heat to the downstream regenerative heaters and raise the feedwater temperature to the solar boiler. This auto adjust mechanism is the result of the extraction steam automatically seeking cooler water in the feedwater stream. In this manner, the efficacy of solar Rankine cycle is enhanced when operated in a standalone operation. When the CT is operational, however, then the CT Feedwater Heater will provide the necessary heating of the feedwater to the solar boiler.

### 3) Elimination of the Reheater

This novelty proposes to eliminate the reheater and the low pressure turbine section proposed by Cohen; this elimination simplifies operations and reduces costs. In practical application, the amount of superheat that can be produced from the waste heat of the CT is typically the amount of heat that optimizes the cycle. The bifurcation of such heat to also supply heat for a reheat cycle is counterproductive to the overall system efficiency. The replacement of the reheat cycle with regenerative heating significantly reduces the operational losses that would be incurred with the Cohen cycle for independent operation of either the solar or CT cycles described in change 1 above. In practice, the amount of heat from the exhaust of a typical CT, at the elevated temperature needed for effective reheating, does not exist in the commercial market. It is more practical, to use the amount of heat in the exhaust of the CT for superheating the main steam flow only.

### 4) Variation of the Steam Flow Parameters from the Solar Boiler

Cohen teaches that the solar boiler should provide only saturated steam and then all superheat is provided by the exhaust heat of the CT. In theory, this may be desirable; however; in practice, it is very limiting and may result in off-optimum results. In practice, greater efficiency will result when the pressure and temperature of the steam from the solar boiler can be varied to optimize with the selected CT. Consequently, the additional of a solar boiler superheater will permit optimization of the system performance.

### 5) Variable Pressure Operation

In order to further enhance the operation of the solar Rankine cycle when the CT is not available, variable pressure operation is proposed as part of this novelty. In this manner heat absorption can be better managed in the solar cycle when CT exhaust heat is not input into the solar Rankine cycle.

These embodiments are more clearly illustrated in FIG. 1 in which Condensate A is received from the condenser and pumped (pump not shown) to the Regen Feedwater Heater(s) which is heated by Extraction Steam N from the steam turbine; zero, partial or full feedwater heating may be needed depending on economics and whether or not the CT is in operation. Multiple heaters may be used either on the low pressure side (condensate) or the high pressure side (feedwater) depending on the economics. The condensate/feedwater B is then directed to the CT Feedwater Heater(s) which receives heat from the CT Exhaust flow L. After heating the condensate/feedwater B, the CT Exhaust Gas M is discharged to the atmosphere. If the CT is not in operation, or as economics dictate, the heated condensate/feedwater C, is then directed to additional Regen Feedwater Heater(s) where the feedwater D is further heated. The heated feedwater D is then directed to the Solar Boiler and Superheater where the feedwater is further heated, vaporized and turned into superheated steam.

As shown in the sketch, valving is provided such that the extraction steam N and/or I may be valved out as necessary during periods of CT operation or as economics dictate. When the CT is operating the feedwater is primarily heated using the CT Feedwater Heater. Although pre-heating of the feedwater using a regenerative feedwater heater prior to the CT Feedwater Heater increases the overall cycle efficiency. Typically, those Regen Feedwater Heaters downstream of the CT Feewater Heater(s) do not require valving due to the automatic self adjust mechanism.

The solar boiler is outfitted with both a saturated boiler and an additional superheater to allow independent operation of the solar Rankine cycle and to allow for optimization of the main steam parameters leaving the solar boiler as economics and technical requirements dictate.

The superheated steam E is then further superheated by the CT exhaust K in the Superheater (typically to ˜1,000 F or as dictated by economics and/or the temperature limitation of the CT exhaust). The remaining heat in the CT exhaust L is then used to heat the condensate/feedwater B. The superheated steam G is directed to the Steam Turbine for expansion. The spent Steam H is then directed to the condenser to complete the closed Rankine cycle.

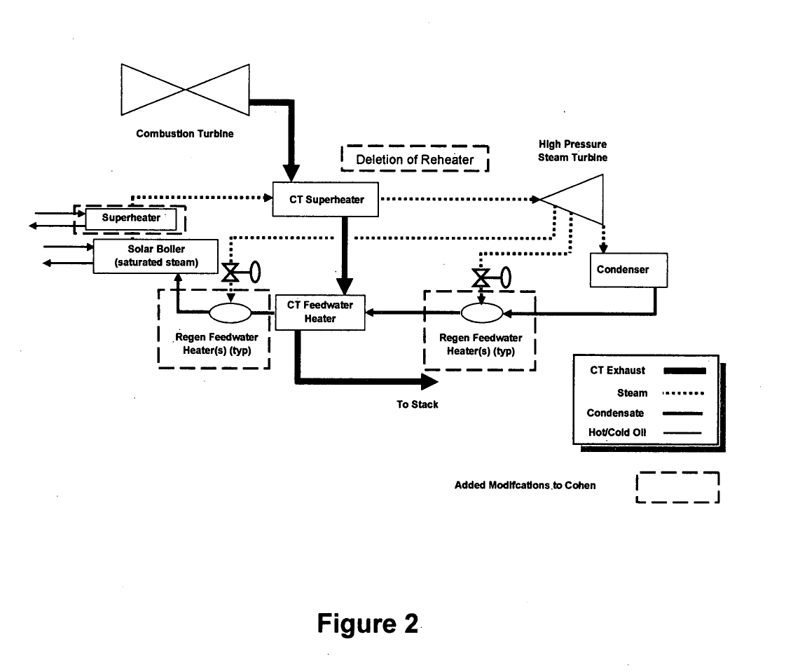

Referring to FIG. 2, the physical differences between the proposed novelty and what Cohen teaches are shown. The addition of regenerative heaters allows the feedwater flow to be heated to an appropriate temperature for boiler feed when exhaust gas from the combustion turbine is not available. In addition, a superheater, using solar heat, is also added to the solar boiler which, under Cohen process, is only capable of saturated steam production. In this manner, the solar superheater provides greater enthalpy to the steam turbine resulting in a higher Carnot efficiency when the combustion turbine is not operating. It also noted in FIG. 2 that the reheat cycle has been deleted as the simplicity of using superheat only and the limitation of available heat in the combustion turbine exhaust gas result in improved economics if the waste heat from the combustion turbine is used solely for superheating.

What is claimed is:

1. A method for generating power comprising a combustion turbine and a solar Rankine cycle power plant utilizing a regenerative feedwater heating system.

2. The method of claim 1, further comprising a combustion turbine and a solar Rankine cycle power plant utilizing a solar superheater to superheat the solar main steam produced from the solar boiler.

3. The method of claim 2, further comprising an exhaust gas superheater wherein all of the exhaust gas heat from the combustion turbine can be first directed to the exhaust gas superheater to further superheat the solar superheated main steam and then any remaining exhaust gas heat can be then directed to a combustion turbine feedwater heater where the heat is transferred to the feedwater.

4. The method of claim 3, wherein the solar Rankine main steam conditions, flow, pressure and temperature are controlled to optimize system efficiency when the combustion turbine is non-operational.
